(19) United States
(12) Patent Application Publication
(10) Pub. No.: US 2008/0060907 A1
(43) Pub. Date: Mar. 13, 2008

(54) Metal Portion-Containing Article, Coin, And Method Of Producing The Same

(76) Inventor: Kenji Oka, Saitama (JP)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 11/570,685

(22) PCT Filed: Dec. 16, 2005
(86) PCT No.: PCT/JP05/23122

§ 371 Date: Dec. 15, 2006

(30) Foreign Application Priority Data
Jun. 2, 2005 (JP) 2005-162739
Aug. 5, 2005 (JP) 2005-227990

(51) Int. Cl. G07D 5/00; B22F 3/11; G07F 1/06; F21K 2/00

(52) U.S. Cl. 194/214; 250/462.1; 419/2

(57) ABSTRACT

Disclosed is a metal portion-containing article having a porous metal portion, in which the porous metal portion contains a substance that emits light by irradiation with an electromagnetic wave. The metal portion-containing article of the present invention cannot be altered or falsified easily, and can be identified.

### TECHNICAL FIELD

The present invention relates to a novel article containing a metal portion, a novel coin, and a method of producing the coin.

### BACKGROUND ART

Conventionally, when hard money and a coin such as a game token for a slot-machine pachinko (reel-type game machine), a slot machine, a TV game machine, or any other game facility are fed in a vending machine, a game facility, a money changer, or the like, the size, shape, surface shape, material, natural frequency, and the like of the coin are detected, whereby it is determined whether the fed coin is an authentic coin or an unauthentic altered or falsified coin.

However, according to such a method, there is the following problem. If a fed coin has the same size, shape, surface shape, material, natural frequency, and the like as those of an authentic coin, the fed coin is recognized to be the authentic coin even if it is an unauthentic coin.

Furthermore, in a game facility-installed shop such as a pachinko and slot parlor, a coin is merely lent to a customer for the purpose of a game, and the customer is prohibited from taking the coin out of the shop.

However, if a customer uses a coin obtained by playing a game in another shop that adopts the same specification of a coin in contravention of the above, there is a problem in that the profit of that shop is impaired.

Furthermore, there are a large number of articles other than a coin, which have a problem of alteration or falsification. For example, in so-called brand-name watch, accessory, lighter, bag, purse, clothes, shoes, ornaments, and the like, the distribution of a forged article is a serious problem.

Furthermore, in an aerospace component, an automobile component, a household electrical appliance component, a housing construction component, a structural component, and the like, there is a serious problem in that a production subcontractor or the like uses a low-grade article that is less expensive than a standardized article.

### DISCLOSURE OF INVENTION

### Problems to be Solved by the Invention

An object of the present invention is to provide a metal portion-containing article, such as a coin, which cannot be altered or falsified easily, and can be identified.

### Means for Solving the Problems

The inventors of the present invention have earnestly studied so as to achieve the above-mentioned object, and consequently, have found the following. When a coin is provided with a porous metal portion (e.g., a sintered metal portion, a sprayed metal portion) containing a substance that emits light by irradiation with an electromagnetic wave, and fed in a vending machine, a game facility, a money changer, or the like, and the emission wavelength and emission strength peculiar to that coin are detected to determine authenticity, a coin cannot be easily altered or falsified, and can be identified.

Furthermore, the inventors of the present invention have also found that the above technique is applicable to various metal portion-containing articles, as well as a coin.

The inventors of the present invention have achieved the present invention based on those findings.

More specifically, the present invention provides the following items (1) to (27).

(1) A metal portion-containing article having a porous metal portion, in which the porous metal portion contains a substance that emits light by irradiation with an electromagnetic wave.

(2) The metal portion-containing article according to the above item (1), in which the porous metal portion is a sintered metal portion.

(3) The metal portion-containing article according to the above item (2), in which the sintered metal portion is a simple substance or an alloy of at least one kind of metal selected from the group consisting of iron, copper, aluminum, titanium, gold, and silver.

(4) The metal portion-containing article according to the above item (2), in which the sintered metal portion is brass, stainless steel, or copper.

(5) The metal portion-containing article according to the above item (1), in which the porous metal portion is a sprayed metal portion.

(6) The metal portion-containing article according to any one of the above items (1) to (5), in which the porous metal portion contains two or more kinds of substances that emit light by the irradiation with electromagnetic waves having different emission wavelengths.

(7) The metal portion-containing article according to any one of the above items (1) to (6), in which the electromagnetic wave is an infrared ray, UV-ray, X-ray, or γ-ray.

(8) The metal portion-containing article according to any one of the above items (1) to (7), in which the porous metal portion further contains DNA.

(9) The metal portion-containing article according to any one of the above items (1) to (8), having a metal portion other than the porous metal portion.

(10) The metal portion-containing article according to any one of the above items (1) to (9), in which a part of a surface of the porous metal portion is a concave portion obtained by pressing or laser application, and light emission of the substance that emits light by the irradiation with an electromagnetic wave is suppressed in the concave portion.

(11) The metal portion-containing article according to the above item (10), in which the surface of the porous metal portion constitutes a two-dimensional bar code.

(12) A coin having a porous metal portion, in which the porous metal portion contains a substance that emits light by irradiation with an electromagnetic wave.

(13) The coin according to the above item (12), in which the porous metal portion is a sintered metal portion.

(14) The coin according to the above item (13), in which the sintered metal portion is a simple substance or an alloy of at least one kind of metal selected from the group consisting of iron, copper, aluminum, and titanium.

(15) The coin according to the above item (13), in which the sintered metal portion is brass, stainless steel, or copper.

(16) The coin according to the above item (12), in which the porous metal portion is a sprayed metal portion.

(17) The coin according to any one of the above items (12) to (16), in which the porous metal portion contains two or more kinds of substances that emit light by the irradiation with electromagnetic waves having different emission wavelengths.

(18) The coin according to any one of the above items (12) to (17), in which the electromagnetic wave is an infrared ray, UV-ray, X-ray, or y-ray.

(19) The coin according to any one of the above items (12) to (18), in which the porous metal portion further contains DNA.

(20) The coin according to any one of the above items (12) to (19), having a metal portion other than the porous metal portion.

(21) The coin according to the above item (20), in which the metal portion other than the porous metal portion is placed around the porous metal portion.

(22) The coin according to any one of the above items (12) to (21), in which a part of a surface of the porous metal portion is a concave portion obtained by pressing or laser application, and light emission of the substance that emits light by the irradiation with an electromagnetic wave is suppressed in the concave portion.

(23) The coin according to the above item (22), in which the surface of the porous metal portion constitutes a two-dimensional bar code.

(24) A method of producing the coin according to any one of the above items (13) to (15) and (17) to (23), including the steps of:

heating powder of at least one kind of metal to a temperature lower than a melting point of the metal; and

cooling the powder from the temperature,

in which in the cooling step, the substance that emits light by the irradiation with an electromagnetic wave is added at a temperature equal to or lower than a stability presence temperature of the substance to obtain the sintered metal portion.

(25) An information recording medium having a porous metal portion,

in which the porous metal portion contains a substance that emits light by irradiation with an electromagnetic wave,

a part of a surface of the porous metal portion is a concave portion obtained by pressing or laser application, and light emission of the substance that emits light by the irradiation with an electromagnetic wave is suppressed in the concave portion, and

the surface of the porous metal portion records information in the concave portion and a portion other than the concave portion, and the information is maintained at least until the concave portion wears out.

(26) The information recording medium according to the above item (25), in which the porous metal portion is a sintered metal portion.

(27) The information recording medium according to the above item (25), in which the porous metal portion is a sprayed metal portion.

### Effects of the Invention

The metal portion-containing article of the present invention such as a coin of the present invention cannot be altered or falsified easily, and can be identified. Furthermore, the method of producing a coin of the present invention can be preferably used for producing a coin of the present invention in which a porous metal portion is a sintered metal portion.

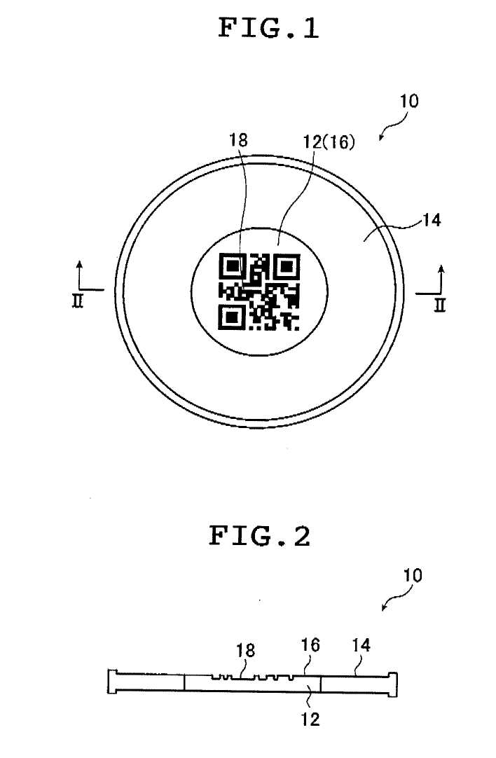

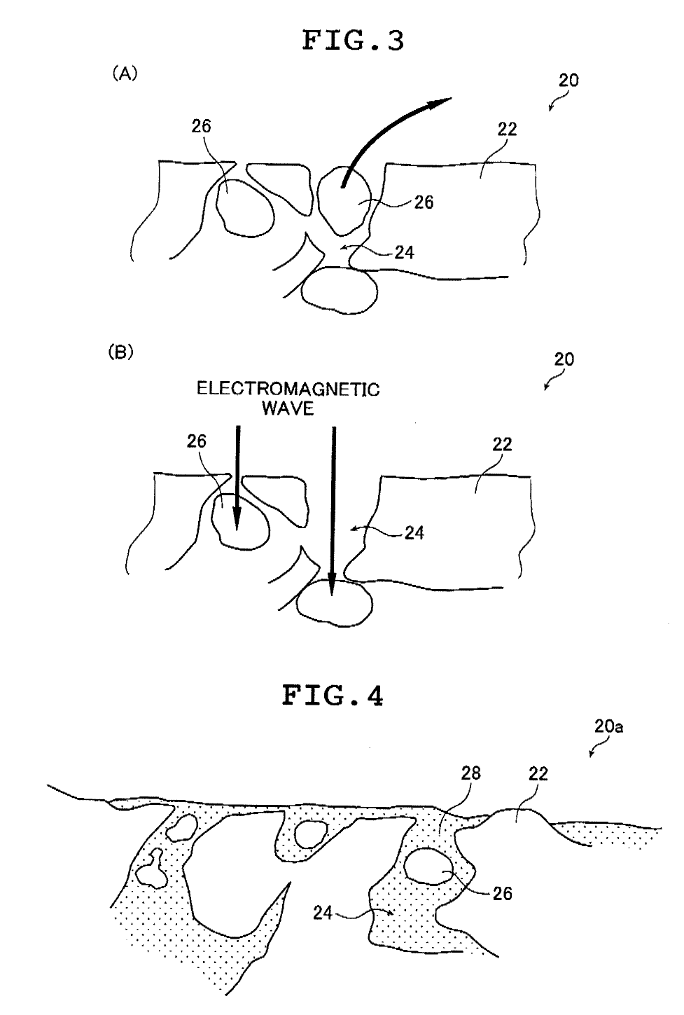

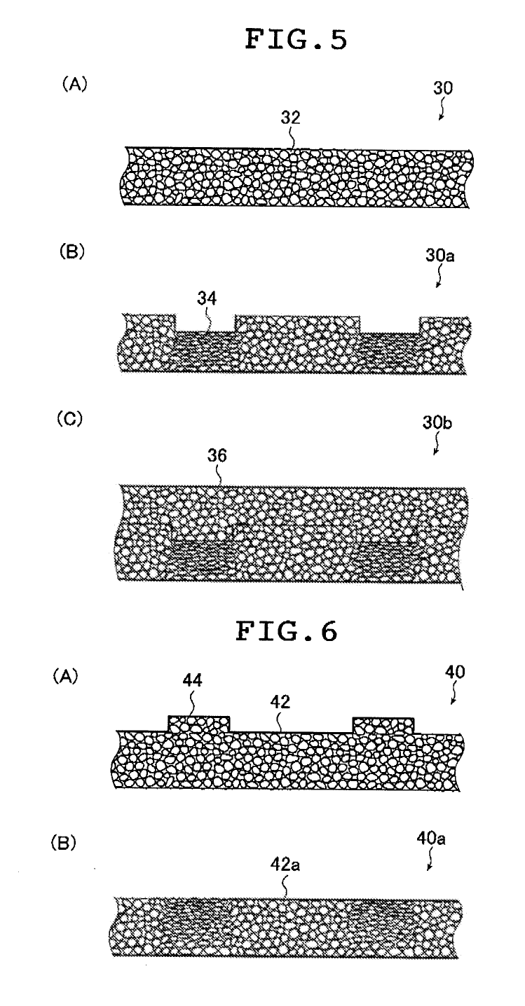

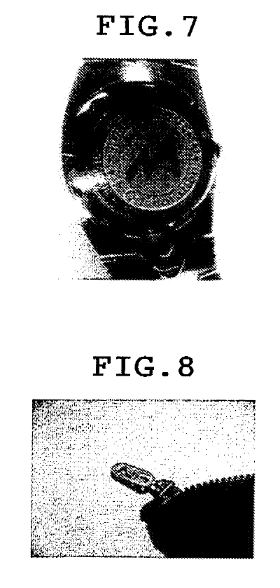

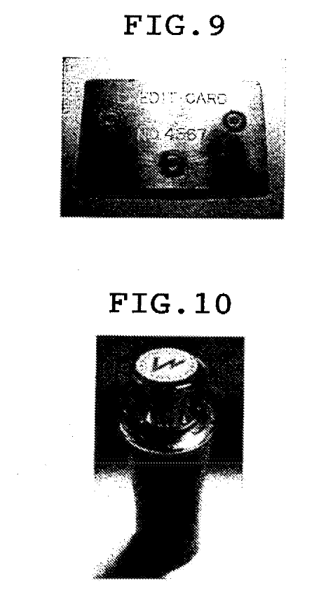

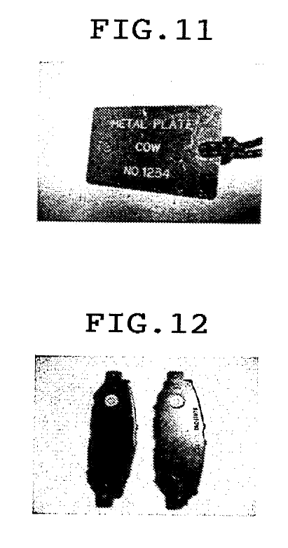

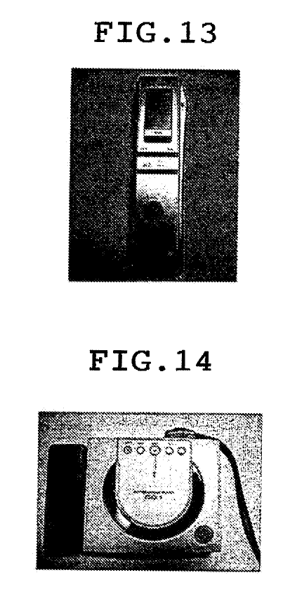

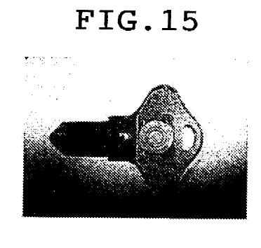

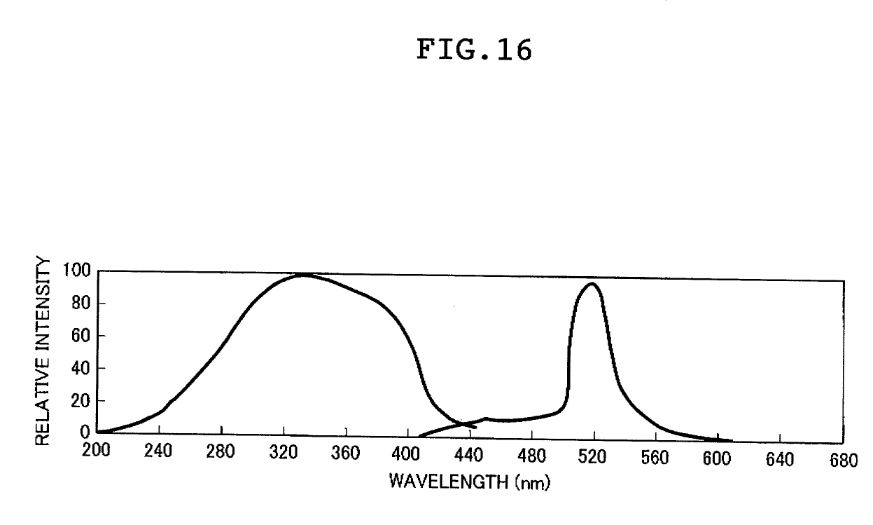

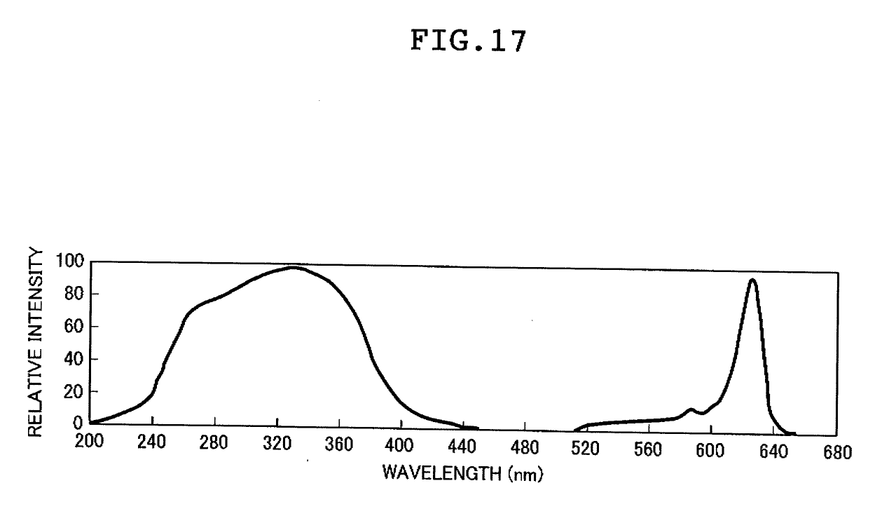

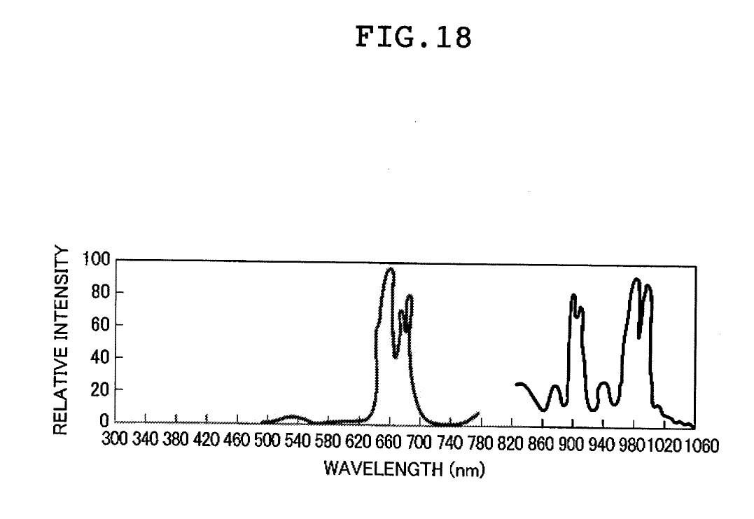

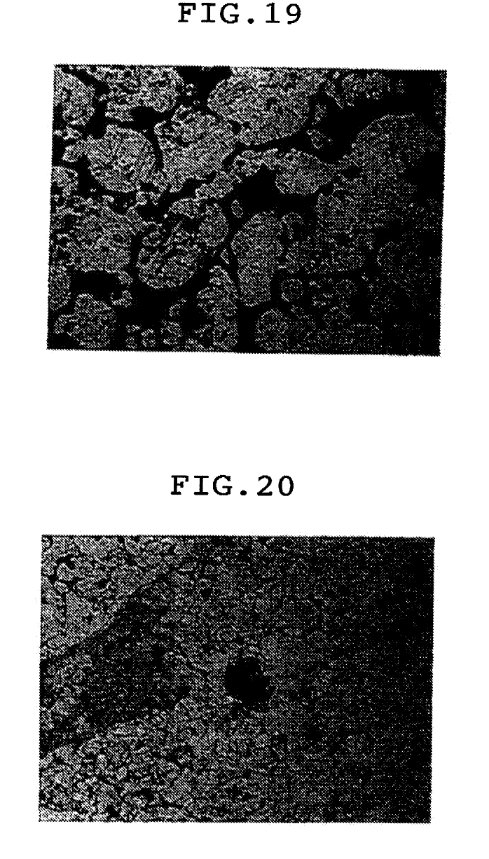

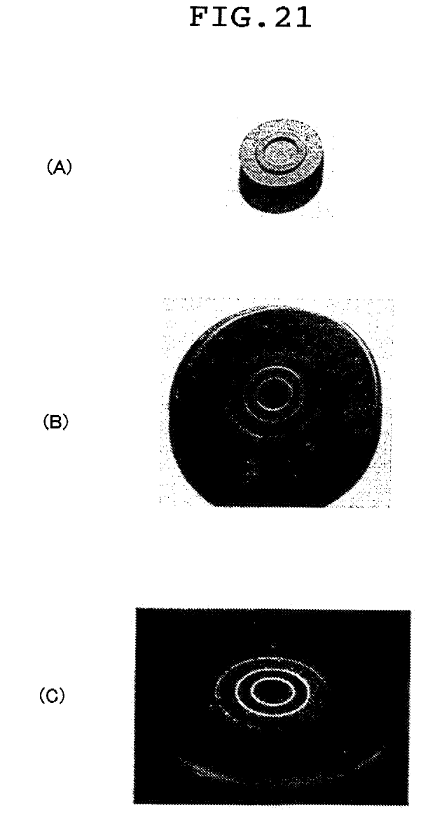

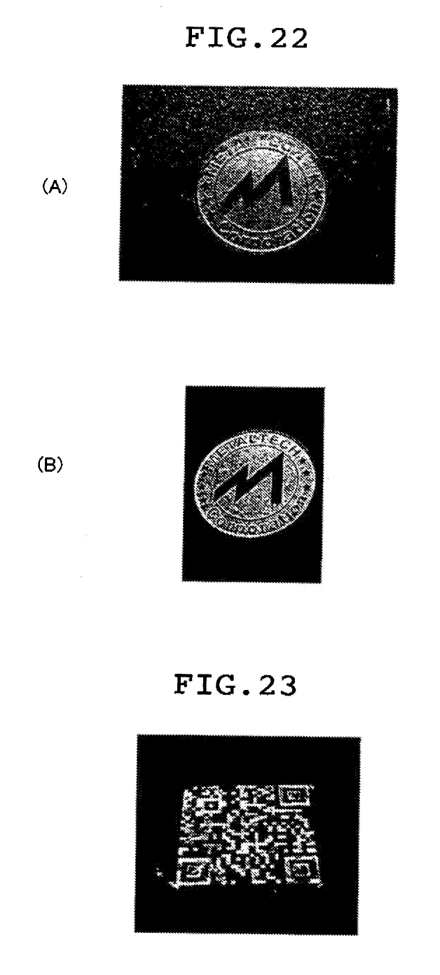

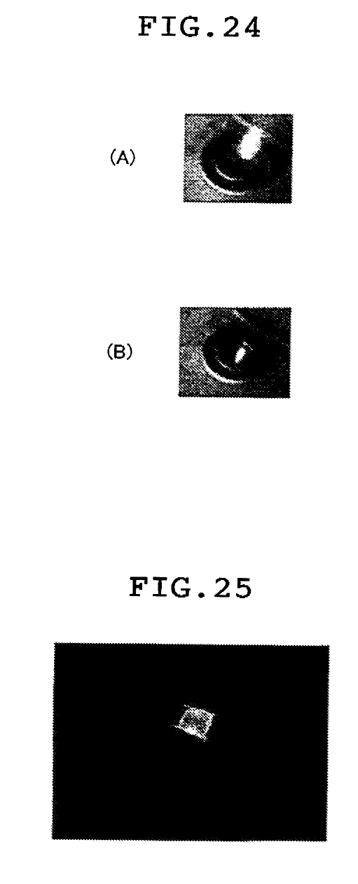

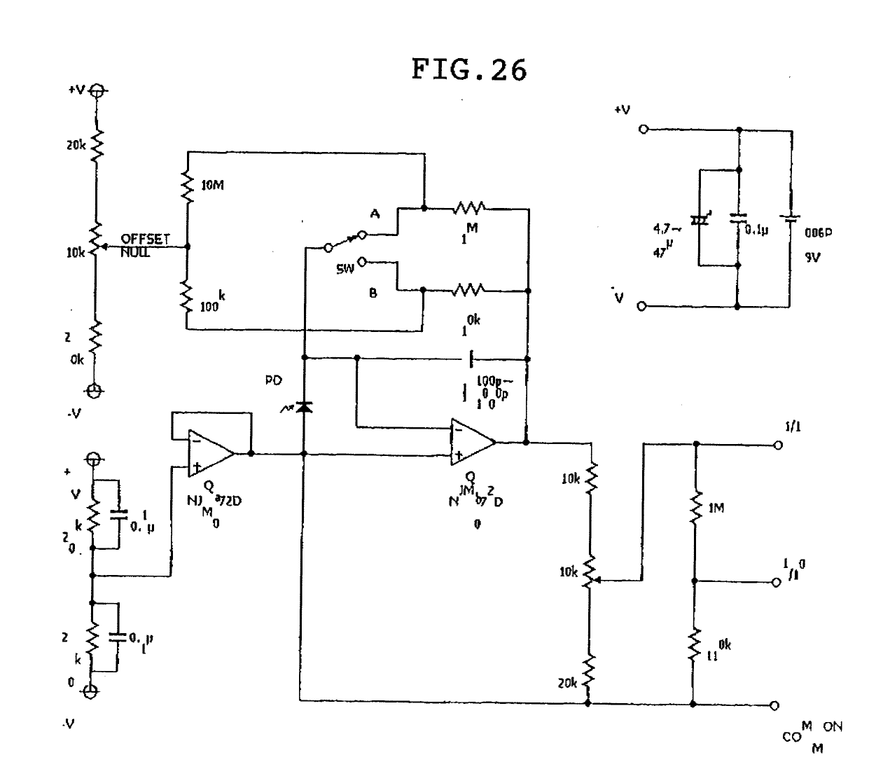

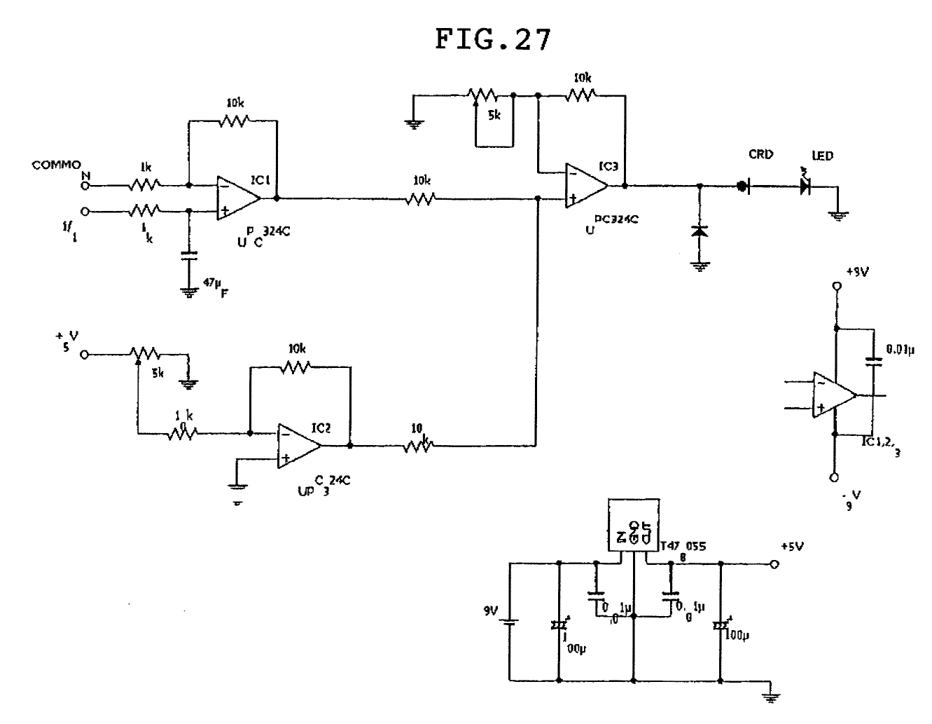

### BRIEF DESCRIPTION OF THE DRAWINGS

[FIG. 1] A schematic plan view showing an example of a coin of the present invention in which a part of a sintered metal portion is a concave portion obtained by pressing or laser application.

[FIG. 2] A horizontal cross-sectional view taken along a line II-II in FIG. 1.

[FIG. 3] Schematic end views showing a metal portion-containing article in which a light-emitting substance is physically fitted in a void of a sintered metal portion.

[FIG. 4] A schematic end view showing a metal portion-containing article in which a light-emitting substance is fixed in a void of a sintered metal portion with an adhesive.

[FIG. 5] Schematic end views showing a method of producing a metal portion-containing article the surface of which is flattened by: forming a concave portion; and then pressing the portion again with metal power placed thereon.

[FIG. 6] Schematic end views showing a sintered metal portion of a metal portion-containing article before and after pressing.

[FIG. 7] A photograph showing a part of a wristwatch having a sintered metal portion containing a light-emitting substance in a metal portion.

[FIG. 8] A photograph showing a part of clothes having a sintered metal portion containing a light-emitting substance.

[FIG. 9] A photograph showing a metallic credit card having a sintered metal portion containing a light-emitting substance.

[FIG. 10] A photograph showing a drug container with a lid having a sintered metal portion containing a light-emitting substance in a metal portion.

[FIG. 11] A photograph showing a tag for livestock having a sintered metal portion containing a light-emitting substance.

[FIG. 12] A photograph showing a brake pad for an automobile having a sintered metal portion containing a light-emitting substance.

[FIG. 13] A photograph showing an IC recorder having a sintered metal portion containing a light-emitting substance.

[FIG. 14] A photograph showing an MD player having a sintered metal portion containing a light-emitting substance.

[FIG. 15] A photograph showing a key having a sintered metal portion containing a light-emitting substance.

[FIG. 16] A graph showing the light-receiving wavelength and emission wavelength of a light-emitting substance (main component: BaMg₂Al₁₆O₂₇: Eu, Mn).

[FIG. 17] A graph showing the light-receiving wavelength and emission wavelength of a light-emitting substance (main component: La₂O₂S: Eu).

[FIG. 18] A graph showing the light-receiving wavelength and emission wavelength of a light-emitting substance (main component: rare-earth oxysulfide).

[FIG. 19] An electron micrograph (magnification: 400) of a cross-section of a sintered metal portion of a metal portion-containing article obtained in Example 3.

[FIG. 20] An electron micrograph (magnification: 100) of a cross-section of a sintered metal portion of a metal portion-containing article obtained in Example 51.

[FIG. 21] Photographs of a sintered body used in Example 15 and a metal portion-containing article obtained in Example 15 before the irradiation with an electromagnetic wave and at the time of irradiation with an electromagnetic wave.

[FIG. 22] Photographs of a metal portion-containing article obtained in Example 6 before the irradiation with an electromagnetic wave and at the time of irradiation with an electromagnetic wave.

[FIG. 23] A photograph of a metal portion-containing article obtained in Example 73 at the time of irradiation with an electromagnetic wave. [FIG. 24] Photographs each in the case where the inside of an O-shaped portion of a metal portion-containing article obtained in Example 74 is irradiated with an electromagnetic wave and in the case where the O-shaped portion is irradiated with an electromagnetic wave. [FIG. 25] A photograph of a metal portion-containing article obtained in Example 75 at the time of irradiation with an electromagnetic wave. [FIG. 26] A circuit diagram of a detector circuit of a detection apparatus used for an emission detection test of a metal portion-containing article in an example. [FIG. 27] A circuit diagram of an amplifier circuit of a detection apparatus used in an emission detection test of a metal portion-containing article in an example.

### LEGEND

10 coin

12, 22, 32, 42, 42a sintered metal portion

14 metal portion

16 surface

18, 34 concave portion

20, 20a, 30, 30a, 30b, 40, 40a metal portion-containing article

24 void

26 light-emitting substance

28 adhesive

36 metal powder

44 convex portion

### BEST-MODE EMBODIMENTS FOR CARRYING OUT THE INVENTION

Hereinafter, a metal portion-containing article of the present invention, a coin of the present invention, and a method of producing the coin will be described in detail.

As described above, the metal portion-containing article of the present invention has a porous metal portion, and the porous metal portion contains a substance that emits light by irradiation with an electromagnetic wave.

The applications of the metal portion-containing article of the present invention are not particularly limited as long as it is an article having a metal portion, and the metal portion-containing article of the present invention can be used for various articles. Examples of the article include a coin, a watch, an accessory, a lighter, a bag, a purse, clothes, shoes, an ornament (e.g., a belt), a metallic credit card, prizes for a pachinko and slot-machine pachinko, household utensils (e.g., a lid of a drug or cosmetic container), an aerospace component, an automobile component (e.g., vehicle components such as a plug, a brake pad, a pedal), a household electrical appliance component (e.g., a small terminal equipment), a housing construction component, a structural component (e.g., a bridge component), and a tag for livestock (e.g., a cow, a chicken).

The configuration and function of the metal portion-containing article of the present invention are not basically limited to those applications. Therefore, hereinafter, the metal portion-containing article of the present invention will be described by exemplifying the case where the article is a coin.

The coin of the present invention has a porous metal portion.

The porous metal portion is a metallic portion in which a number of fine holes are present. The porous metal portion is not particularly limited, and examples thereof include a sintered metal portion and a sprayed metal portion.

The sintered metal portion is obtained by sintering powder of at least one kind of metal.

The sintering can be performed by a conventionally known method, excluding using a substance that emits light by irradiation with an electromagnetic wave in a method of producing a coin of the present invention described later. The sintered metal portion thus obtained has a number of fine holes.

It is one preferable embodiment that the sintered metal portion is a simple substance or an alloy of at least one kind of metal selected from the group consisting of iron, copper, aluminum, titanium, gold, and silver. Of those, brass, stainless steel, and copper are preferable.

The sprayed metal portion is formed by spraying.

The spraying refers to a method of forming a coating film (sprayed metal portion) involving: melting by heating, or softening, a coating material to form it into fine particles; accelerating the fine particles so that they bump into a surface of an object to be covered; and coagulating and depositing the coating material. The sprayed metal portion thus obtained has a number of fine holes.

The coating material is not particularly limited, and examples thereof include conventionally known materials such as metal (e.g., zinc, aluminum, steel; and alloys thereof), ceramics, cermet, and plastic. Examples of the form thereof include a wire flame, a rod flame, and powder.

The object to be covered is not particularly limited, and examples thereof include conventionally known objects such as metal (including an alloy), ceramics, cermet, and plastic.

A spraying method is not particularly limited, and for example, a conventionally known method can be used. Examples of the kind of a heat source include gas and electricity.

As described above, although the porous metal portion is not particularly limited, hereinafter, a description will be made using a sintered metal portion as an example of the porous metal portion. In the metal portion-containing article and coin of the present invention, it is appreciated that a porous metal portion other than a sintered metal portion (e.g., a sprayed metal portion) can be used instead of the sintered metal portion.

The coin is not particularly limited as long as it is of a plate shape. For example, the coin can be formed in a circular shape, an oval shape, a polygonal shape (e.g., a regular polygon), or an indefinite shape. Those shapes may be slightly deformed.

The coin may have a portion other than the sintered metal portion. The material for the portion other than the sintered metal portion is not particularly limited, and for example, the material used for a conventional coin can be used. Specifically, examples include elemental metal, an alloy, plastic, glass, and ceramics.

In the case where the coin has a portion other than the sintered metal portion, the shapes, positions, sizes, number, and the like of sintered metal portions are not particularly limited.

The shape of the sintered metal portion can be, for example, a circle, an oval, a polygon (e.g., a regular polygon), a donut shape, and an indefinite shape. Those may be slightly deformed. Furthermore, in the thickness direction, such a shape may be present over an entire region or in a partial region.

It is preferable that the sintered metal portion be positioned at the center of the coin in terms of ease of detection.

Regarding the size of the sintered metal portion, in order to allow the sintered metal portion to be present at a desired position even if the position is slightly shifted inside a vending machine or the like, a portion exposed to the surface is preferably 0.01 mm or more, and more preferably 0.1 mm or more.

Although the number of the sintered metal portions may be at least one per one surface, two or more sintered metal portions can be present.

Above all, it is preferable that the coin have a metal portion other than the sintered metal portion. In this case, it is preferable that the metal portion other than the sintered metal portion be placed around the sintered metal portion. Specifically, an exemplary configuration is composed of a circular sintered metal portion and a donut-shaped metal portion surrounding the circular sintered metal portion (so-called bimetal coin). More preferably, the coin is composed of a circular sintered metal portion with a diameter of 0.01 to 25 mm and a donut-shaped metal portion that is to be concentric therewith.

As the metal portion other than the sintered metal portion, an alloy is preferable. Preferable examples of the alloy include stainless steels such as SUS 304. Of those, SUS 304 is preferable in terms of the absence of magnetism.

In the present invention, the above-mentioned sintered metal portion contains a substance that emits light by irradiation with an electromagnetic wave (hereinafter, which may be also referred to as a “light-emitting substance”). The light-emitting substance is not particularly limited as long as it emits light by irradiation with an electromagnetic wave.

The electromagnetic wave is not particularly limited, and examples thereof include infrared rays, UV-rays, X-rays, and γ-rays. Of those, infrared rays are preferable.

A conventionally known substance can be used as the substance that emits light by irradiation with an electromagnetic wave.

Furthermore, the light-emitting substance may be a substance that continues to emit light for a certain period of time even after the completion of the irradiation with an electromagnetic wave (i.e., a so-called luminous substance).

In the present invention, it is one preferable embodiment that the sintered metal portion contains two or more kinds of substances that emit light by irradiation with electromagnetic waves having different emission wavelengths.

In this case, two or more kinds of emission wavelengths are obtained, and a combination of emission strengths can be variously changed by selecting the amount ratio of these light-emitting substances in the sintered metal portion. Therefore, it is difficult to analyze the amount ratio, and consequently, it becomes very difficult to alter or falsify a coin to be obtained. Furthermore, a coin peculiar to a shop in which the coin is to be used can be obtained by appropriately selecting an amount ratio. As a result, it becomes possible to identify the coin.

The embodiment of a coin containing two or more kinds of light-emitting substances having different emission wavelengths is not particularly limited. Examples thereof include a combination of light-emitting substances that emit light at two or more kinds of emission wavelengths with one kind of electromagnetic wave and a combination of light-emitting substances that emit light at two or more kinds of emission wavelengths with two or more kinds of electromagnetic waves. Examples include a combination of two kinds of infrared-emitting substances that emit light at different emission wavelengths and a combination of an infrared-emitting substance and a UV-emitting substance that emit light at different emission wavelengths.

Although the amount of the light-emitting substance is not particularly limited, the amount is preferably 0.01 to 3.0 wt % based on the entire mass of the sintered metal portion. The amount in this range is sufficient for identifying a coin, without costing a lot.

The sintered metal portion can further contain deoxyribonucleic acid (DNA). By appropriately selecting DNA to be contained, it becomes very difficult to alter or falsify a coin, and the precision for identifying a coin becomes extremely high.

The kind of DNA is not particularly limited, and any DNA of a plant and an animal can be used. The kinds of the plant and the animal are not particularly limited. DNA of a human being can be used as DNA of an animal.

For example, commercially available DNA can be used. Of those, DNA collected from a plant or an animal, cultured and pulverized, may be used preferably.

One kind of DNA may be used alone, or two or more kinds of DNA are used in a combination.

The amount of DNA is not particularly limited, and is preferably 0.01 to 3.0 wt % based on the entire amount of the sintered metal portion. The amount in this range is sufficient for identifying a coin, without costing a lot.

Furthermore, the sintered metal portion can further contain a photocatalyst. In the case where the sintered metal portion contains a photocatalyst, disinfectant, antibacterial, reodorant, deodorant, soil-resistant, anticorrosive effects, and the like can be obtained by irradiation with an electromagnetic wave. For example, a finger mark is unlikely to adhere to the sintered metal portion of a coin, and even in the case where the finger mark adheres thereto, it can be easily removed.

The photocatalyst is not particularly limited, and an example thereof includes titanium oxide.

There is no particular limit to how the light-emitting substance, DNA, and photocatalyst are contained in the sintered metal portion.

For example, a light-emitting substance or the like may merely be fitted physically in a void of the sintered metal portion, may be fixed in a void of the sintered metal portion with an adhesive or the like, or may be partially buried on the metal surface of the sintered metal portion.

FIG. 3 are schematic end views each showing a metal portion-containing article in which a light-emitting substance is fitted physically in a void of a sintered metal portion.

In a metal portion-containing article 20 shown in FIG. 3(A), a light-emitting substance 26 is fitted physically in a void 24 of a sintered metal portion 22. The metal portion-containing article 20 shown in FIG. 3(A) has the light-emitting substance 26 inside in the vicinity of the surface. Therefore, even in the case where a part of the light-emitting substance 26 peels off, the light-emitting substance 26 inside can receive an electromagnetic wave, as shown in FIG. 3(B). Thus, even in the case where a light-emitting substance peels off slightly, the emission performance will not reduce rapidly.

FIG. 4 is a schematic end view showing a metal portion-containing article in which a light-emitting substance is fixed in a void of a sintered metal portion with an adhesive.

In a metal portion-containing article 20a shown in FIG. 4, the light-emitting substance 26 is fixed in the void 24 of the sintered metal portion 22 with an adhesive 28. This embodiment is preferable since the light-emitting substance 26 is unlikely to peel off, and the strength and oxidation resistance of the sintered metal portion 22 are excellent.

In the case of using an adhesive, the adhesive is not particularly limited, and a conventionally known adhesive can be used. Examples of the adhesive include: a synthetic resin adhesive such as a urea resin adhesive, a melamine resin adhesive, a phenolic resin adhesive, an epoxy resin adhesive, a vinyl acetate resin adhesive, a cyanoacrylate-based adhesive, a polyurethane-based adhesive, an α olefin-maleic anhydride resin adhesive, a reactive acrylic resin adhesive, or an ultraviolet (UV)-curable modified acrylic resin adhesive; an emulsion adhesive such as a vinyl acetate resin-based emulsion adhesive, a vinyl acetate copolymeric resin-based emulsion adhesive, an EVA resin-based emulsion adhesive, or an acrylic resin-based emulsion adhesive; a hot melt adhesive such as a reactive hot melt adhesive, an EVA-based hot melt adhesive, an elastomeric hot melt adhesive, or a polyamide-based hot melt adhesive; and a synthetic rubber-based adhesive such as a chloroprene rubber-based solvent adhesive or a synthetic rubber-based latex adhesive.

Of those, UV-curable adhesives such as a radical-polymerizable acrylic resin adhesive, cation-polymerizable epoxy resin adhesive, and a radical-addition type polyene/thiol adhesive are preferably used. In the case of using a UV-curable adhesive, the UV-curable adhesive is cured immediately by irradiation with UV-rays, so that production efficiency becomes excellent. Furthermore, using a UV-emitting substance as a substance that emits light by irradiation with an electromagnetic wave is preferable because the presence thereof can be confirmed when an adhesive is cured by irradiation with UV-rays.

Furthermore, the epoxy resin adhesive can be used preferably in terms of the excellent adhesion and weather resistance.

Furthermore, it is one preferable embodiment of the coin of the present invention that a part of the surface of the sintered metal portion is a concave portion obtained by pressing or laser application, and the light emission of a light-emitting substance is suppressed in the concave portion.

FIG. 1 is a schematic plan view showing an exemplary coin of the present invention in which a part of a sintered metal portion is a concave portion obtained by pressing or laser application. Furthermore, FIG. 2 is a horizontal cross-sectional view taken along a line II-II in FIG. 1.

The coin 10 shown in each of FIGS. 1 and 2 has a sintered metal portion 12 and a metal portion 14 other than the sintered metal portion, and the metal portion 14 is placed around the sintered metal portion 12.

In the sintered metal portion 12, a part of a surface 16 is a concave portion 18 (portion represented in black in FIG. 1) obtained by pressing. Thus, the light emission of the light-emitting substance in the concave portion 18 is suppressed.

The light-emitting substance fills a void of the sintered metal portion 12, and in the concave portion 18, the void in the vicinity of the surface of the sintered metal portion 12 is compressed by pressing to become small. Therefore, in the concave portion 18, an electromagnetic wave is unlikely to reach the light-emitting substance, and light emitted from the light-emitting substance is unlikely to come out. This is considered to suppress the light emission of the light-emitting substance in the concave portion 18. Furthermore, in the case of forming a concave portion by means of laser application, metal on the surface of the concave portion dissolves and the void becomes small. As a result, the light emission of the light-emitting substance may be suppressed. Furthermore, even according to a method other than pressing or laser application, the same effects can be obtained by forming a concave portion in accordance with a method of decreasing a void in the vicinity of the surface of the concave portion.

In the coin 10 shown in each of FIGS. 1 and 2, the light emission of the light-emitting substance is suppressed in the concave portion 18. Therefore, when an electromagnetic wave is applied, the degree of light emission of the light-emitting substance varies between a portion other than the concave portion 18 of the surface 16 where the light emission is not suppressed and the concave portion 18 where the light emission is suppressed. Thus, by forming a pattern (e.g., a one-dimensional bar code, a two-dimensional bar code described later) by a portion where the light emission of the light-emitting substance is large and a portion where the light emission thereof is small (or there is substantially no light emission), alteration or falsification is unlikely to be performed, and the precision for identifying a coin increases additionally.

FIG. 5 are schematic end views showing a method of producing a metal portion-containing article the surface of which is flattened by forming a concave portion by the same method as the above, followed by pressing again with metal powder placed thereon.

A sintered metal portion 32 of a metal portion-containing article 30 before pressing shown in FIG. 5(A) is pressed to obtain a metal portion-containing article 30a having a concave portion 34 (see FIG. 5(B)), and further, the metal portion-containing article 30a is pressed again with metal powder 36 placed thereon, whereby a metal portion-containing article 30b shown in FIG. 5(C) is obtained.

In this embodiment, the void in the vicinity of the concave portion becomes small by the initial pressing, and the light emission in that portion is suppressed. Furthermore, no light-emitting substance is contained in the vicinity of the flat surface, so that the light-emitting substance does not peel off owing to abrasion or the like.

The same effects as those of the embodiment in which it is preferable that a part of the surface of the above-mentioned sintered metal portion be a concave portion by pressing or laser application, and the light emission of a light-emitting substance be suppressed in the concave portion (and the embodiment in which the sintered metal portion is pressed again with metal powder placed thereon) can be obtained in an embodiment using another method of deceasing a void of a portion where the light emission is suppressed.

For example, in the case where it is desired to obtain a flat sintered metal portion, a portion where the light emission is desired to be suppressed is formed as a convex portion, and an entire surface of the sintered metal portion is pressed to crush the convex portion, whereby a flat surface in which the void in the portion where the light emission is desired to be suppressed is small can be obtained.

FIG. 6 are schematic end views each showing a sintered metal portion of a metal portion-containing article before and after pressing.

A sintered metal portion 42 before pressing of a metal portion-containing article 40 shown in FIG. 6(A) has a convex portion 44. In the sintered metal portion 42a after pressing of the metal portion-containing article 40a shown in FIG. 6(B), the convex portion 44 before pressing is crushed, whereby a void in the vicinity thereof becomes small and the light emission in that portion is suppressed. In Examples 1-3, 7-9, 13-15, 19-21, 25-27, 31-33, 37-39, 43-45, 49-51, 55-57, 61-63, and 67-69 described later, this embodiment is used.

In each of those embodiments, it is one preferable embodiment that the surface of a sintered metal portion constitutes a two-dimensional bar code.

In the coin 10 shown in each of FIGS. 1 and 2, as described above, there are a portion where the light emission of a light-emitting substance is large and a portion where the light emission thereof is small (or where there is substantially no light emission), and both the portions together constitute a two-dimensional bar code on the surface 16. In the case where an electromagnetic wave is applied, a portion where the light emission of a light-emitting substance is large and a portion where the light emission thereof is small (or where there is substantially no light emission) are formed. Therefore, by placing the coin 10 in a two-dimensional bar code reader having incorporated therein an apparatus for detecting the light emission of a light-emitting substance, the light emission of the light-emitting substance can be detected as a two-dimensional bar code.

By matching information on the detected two-dimensional bar code with previously registered data of an authentic article, the authenticity can be determined. Specifically, for example, by accessing database of the authentic article via the Internet, the authenticity on the detected two-dimensional bar code can be determined. There is no particular limit to the information recorded in a two-dimensional bar code. For example, production information such as a producer name, a seller name, a production date, a production lot, and a product manual can be recorded in a two-dimensional bar code as the information.

In the coin 10 shown in each of FIGS. 1 and 2, one two-dimensional bar code is formed on one surface. However, the present invention is not limited thereto. Concave portions may be formed on both surfaces, and a plurality of two-dimensional bar codes may be formed on one surface.

In the case where the surface of a sintered metal portion constitutes a bar code such as a two-dimensional bar code, even if the surface wears out owing to the long-term use, cleaning, and the like, information can be read. This is very useful because the loss of information caused by peeling or the like of ink, which is a problem in a conventionally printed bar code, can be overcome.

Although there is no particular limit to the method of producing the coin of the present invention, the following methods (1) to (3) are preferably used.

(1) A method including the step of obtaining a sintered metal portion by sintering powder of at least one kind of metal, and the step of filling a void of the sintered metal portion with a light-emitting substance.

(2) A method including the step of obtaining a sprayed metal portion by melting by heating, or softening, a coating material, pulverizing the coating material, accelerating it so that it bumps into the surface of an object to be coated, and coagulating and depositing the coating material, and the step of filling a void of the sprayed metal portion with a light-emitting substance.

(3) A method of obtaining a sintered metal portion, including the step of heating powder of at least one kind of metal to a temperature lower than the melting point of the metal, and the step of cooling it from the temperature, in which in the cooling step, a substance that emits light by irradiation with an electromagnetic wave is added at a temperature equal to or lower than its stability presence temperature (method of producing a coin of the present invention).

(4) A method of obtaining a sintered metal portion by sintering mixed powder of at least one kind of metal and powder of a light-emitting substance.

In the above method (1), first, the step of obtaining a sintered metal portion by sintering powder of at least one kind of metal is performed. A conventionally known method can be used as the sintering method.

For example, by successively performing the compressing step involving placing metal powder and a lubricant such as zinc stearate and a reinforcing agent used arbitrarily in a forming press, compressing the metal powder normally with a pressure of about 4 to 8 MPa by upper and lower punches in a die set in the forming press, and forming the powder into a desired plate shape, the heating step of heating the obtained compressed material in a sintering furnace, the cooling step of cooling the heated compressed material to obtain a sintered body, and the sizing (coining) step of compressing the sintered body in the die, which is arbitrarily performed, a plate-shaped sintered metal portion can be obtained.

By including a material causing oxidation in metal powder or the like and sintering it using high-pressure and high-temperature water vapor, a sintered body in a state where metal is completely oxidized can be obtained. In this case, the sintered metal portion has already been oxidized, so that there is an advantage in that a problem such as discoloring caused by oxidation does not occur even in long-term use.

Furthermore, in the compressing step, in the case where a lubricant is used and in the case where powder of two or more kinds of metals are used, it is preferable to previously mix them by a mixer or the like.

Then, the step of filling a void of a sintered metal portion with a light-emitting substance is performed. The light-emitting substance may fill the void alone, or may fill the void after being mixed with DNA, a photocatalyst, an adhesive, or the like.

It is one preferable embodiment that this step is performed under a reduced pressure, whereby the efficiency of filling the void with the sintered metal portion is enhanced.

Furthermore, it is one preferable embodiment that this step is performed in such a manner that a substance wettable with a sintered metal portion is mixed with a light-emitting substance and fills in the void by impregnation. This embodiment has the following advantages. Only the desired portion can be filled by coating using a masking material to cover a portion not to be filled with the light-emitting substance. In this case, the filling can be also performed under a reduced pressure. The substance wettable with the sintered metal substance is not particularly limited, and may be an alkoxysilane compound, for example. The alkoxysilane compound is preferable because the compound reacts with water in the air to cure. The alkoxysilane compound is not particularly limited, and examples thereof include: tetraalkoxysilane such as tetramethoxysilane or tetraethoxysilane; trialkoxyalkylsilane or trialkoxyallylsilane such as methyl trimethoxysilane, methyl triethoxysilane, phenyl trimethoxysilane, or phenyl triethoxysilane; dialkcoxy dialkylsilane or dialkoxy diallylsilane such as dimethyl dimethoxysilane, dimethyl diethoxysilane, diphenyl dimethoxysilane, or diphenyl diethoxysilane; and condensates thereof. One kind of the compounds may be used alone or two or more kinds of the compounds may be used together. Furthermore, a commercially available sealer containing an alkoxysilane compound (for example, a permeate manufactured by D and D ltd.) can be also used.

It is preferable that the light-emitting substance fills not only the void in the vicinity of the surface of the sintered metal portion but also the void inside thereof, because even in the case where a coin wears out owing to the use, cleaning, and the like, the light-emitting substance is always present on the surface of the coin. In the case of using an adhesive, thereafter, the adhesive is cured by a curing method depending on the used adhesive. In the case of using an adhesive, it is preferable to set the content of a light-emitting substance in a composition of the adhesive or the like to be about 0.16 to 3.0 wt %.

Subsequently, the aftertreatment steps such as water vapor treatment, barrel polishing, and shot blasting can also be performed.

In the above-mentioned method (2), first, the step of obtaining a sprayed metal portion by melting by heating, or softening, a coating material, pulverizing the coating material, accelerating it so that it bumps into the surface of an object to be coated, and coagulating and depositing the coating material is performed. A conventionally known method can be used as the spraying method.

Then, the step of filling a void of the sprayed metal portion with a light-emitting substance is performed. This step can be performed in the same way as in the step of filling a void of the sintered metal portion with a light-emitting substance in the above-mentioned method (1).

In the above-mentioned method (3), first, powder of at least one kind of metal and a lubricant (in the case of using a lubricant and in the case of using powder of two or more kinds of metal, it is preferable to previously mix them by a mixer or the like) such as zinc stearate used arbitrarily are formed into a plate-shaped compressed material by the compressing step, and thereafter, the heating step of heating the compressed material to a temperature lower than the melting point of the metal is performed. The heating step can be performed by a conventionally known method, for example, the same method as that of the above-mentioned method (1).

Then, the cooling step of cooling the compressed material from the temperature in the heating step is performed, and in the cooling step, a light-emitting substance is added at a temperature equal to or lower than its stability presence temperature. Because of this, in the cooling step, before sintering is completed, a light-emitting substance can brought into contact with the surface of powder of metal that is being sintered. Consequently, a sintered metal portion in a state where a light-emitting substance is partially buried in the metal surface is obtained.

Herein, the “stability presence temperature” of the light-emitting substance refers to a temperature at which the light-emitting substance can be present stably without undergoing burning, volatilization, denaturalization, and the like.

The temperature in the heating step is lower than the melting point of metal to be used. When the temperature in the heating step is higher than the stability presence temperature of the light-emitting substance, the light-emitting substance undergoes burning, volatilization, denaturalization, and the like, with the result that the effects of the present invention may not be obtained. According to the above-mentioned method (3), the burning, volatilization, denaturalization, and the like of the light-emitting substance do not occur.

Furthermore, according to the above-mentioned method (3), a light-emitting substance can be fixed on the surface of metal in the sintered metal portion without using an adhesive.

In the above-mentioned method (3), in the case of using DNA, DNA is added at a temperature equal to or lower than its stability presence temperature in the cooling step. The meaning of the “stability presence temperature” here is the same as that in the case of a light-emitting substance.

It is preferable that the cooling step be performed under a reduced pressure so that the adhesion efficiency to the surface of metal in the sintered metal portion is enhanced. It is preferable that the light-emitting substance adhere to not only the surface of a metal particle in the vicinity of the surface of the sintered metal portion but also the surface of a metal particle inside the sintered metal portion, because even in the case where a coin wears out owing to the use, cleaning, and the like, the light-emitting substance is always present on the surface of the coin.

After that, the sizing (coining) step, and aftertreatment steps such as water vapor treatment, barrel polishing, and shot blasting can also be performed.

The above-mentioned method (4) can be performed in the same way as in the above-mentioned method (1) except that sintering is performed after powder of a light-emitting substance is mixed with powder of at least one kind of metal.

In any method, the obtained plate-shaped sintered metal portion may be used straightly as a coin, or may be combined with a portion other than the sintered metal portion (for example, a metal portion other than the above-mentioned sintered metal portion) to form a coin. A conventionally known method (for example, a conventionally known method of producing a bimetal coin, more specifically, a method using connection by pressing, clamping, calking, adhesive, etc.) can be used as a method of combining a sintered metal portion with a metal portion other than the sintered metal portion to form a coin.

Furthermore, in an embodiment that the coin of the present invention in which a part of the surface of the sintered metal portion is a concave portion obtained by pressing or laser application, for example, it is possible to use a method of obtaining a sintered metal portion by the above-mentioned method, and thereafter, pressing a part of the surface of the sintered metal portion to form a concave portion. Examples include a method (method A) of obtaining a coin by performing the step of forming a concave portion by means of pressing or laser application after the step of filling a light-emitting substance in the above-mentioned method (1), and a method (method B) of obtaining a coin by forming a concave portion by means of pressing or laser application after the cooling step in the above-mentioned method (3).

Furthermore, it is also possible to use a method (method C) of obtaining a coin by performing the step of forming a concave portion by means of pressing or laser application between the step of obtaining a sintered metal portion and the step of filling a light-emitting substance in the above-mentioned method (1). According to this method, there is an advantage in that the filling amount of a light-emitting substance can be reduced.

In an embodiment that the coin of the present invention in which a part of the surface of the sprayed metal portion is a concave portion obtained by pressing or laser application, for example, in the same manner as that described above, it is possible to use a method of obtaining a sprayed metal portion by the above-mentioned method, and thereafter, pressing a part of the surface of the sprayed metal portion to form a concave portion. Examples include a method (method D) of obtaining a coin by performing the step of forming a concave portion by means of pressing or laser application after the step of filling a light-emitting substance in the above-mentioned method (1).

Furthermore, it is also possible to use a method (method E) of obtaining a coin by performing the step of forming a concave portion by means of pressing or laser application between the step of obtaining a sprayed metal portion and the step of filling a light-emitting substance in the above-mentioned method (1). According to this method, there is an advantage in that the filling amount of a light-emitting substance can be reduced.

In the methods A to E, if forming a concave portion, it is preferable to form a concave portion by means of pressing for the purpose of remarkably enhancing the abrasion resistance and strength of a sintered metal portion or a sprayed metal portion. The method of pressing is not particularly limited, and a preferable example includes a method using a press machine. The pressing is performed normally at a pressure of 5 to 20 t/cm².

In the case where the entire coin of the present invention is formed of a sintered metal portion or a sprayed metal portion, rimming (formation of an edge) can also be performed concurrently with the formation of a concave portion at the time of pressing. This also similarly applies to the case where the coin of the present invention is formed by combining a sintered metal portion or a sprayed metal portion with a metal portion other than the sintered metal portion or the sprayed metal portion.

The coin of the present invention is identified as follows.

A sintered metal portion of a coin to be identified is irradiated with an electromagnetic wave capable of allowing a light-emitting substance used in an authentic coin to emit light. On the other hand, the emission wavelength of the light-emitting substance used in the authentic coin is detected with a detector. If the coin to be identified is an authentic coin, the emission wavelength of the light-emitting substance is detected.

Furthermore, in the case of using two or more kinds of light-emitting substances having different emission wavelengths, the above-mentioned detection is performed for each emission wavelength.

Furthermore, in the case of using two or more kinds of electromagnetic waves, the above-mentioned irradiation with each electromagnetic wave is performed.

Furthermore, in the case where a part of the surface of a sintered metal portion is a concave portion obtained by pressing or laser application, information is read from a pattern composed of the difference in degree of light emissions between light-emitting substances, and is matched with previously registered data on an authentic product, whereby identification can be performed.

Furthermore, in the case where an authentic coin contains DNA in a composition, the composition of the coin to be identified is collected for DNA analysis. The DNA analysis is preferably performed in the case where a great amount of coins are suspected of having been falsified.

The DNA analysis can be performed, for example, by a conventionally known method. If the coin to be identified is an authentic coin, DNA contained in the authentic coin is detected.

Thus, the metal portion-containing article of the present invention has been described by exemplifying the coin of the present invention. However, the present invention is not limited thereto, and for example, the configuration of each part may be replaced by an arbitrary configuration capable of exhibiting a similar function.

Furthermore, the configurations of respective parts in each embodiment can also be combined arbitrarily to obtain another embodiment.

Examples of the metal portion-containing article of the present invention include articles in each of which a metal portion of a metal portion-containing article such as a watch, an accessory, a lighter, a bag, a purse, clothes, shoes, or an ornament includes a sintered metal portion containing the above-mentioned light-emitting substance. More examples include articles in each of which a sintered metal portion containing the above-mentioned light-emitting substance is provided on: a reverse surface of a body of a watch; a button, a fastener, or the like of clothes; a metallic credit card, a prize of a pachinko, a slot-machine pachinko, or the like.

FIG. 7 is a photograph showing a part of a wristwatch having a sintered metal portion containing a light-emitting substance in a metal portion. In the wristwatch shown in FIG. 7, a sintered metal portion containing a light-emitting substance is provided on a reverse surface of a body of a watch.

FIG. 8 is a photograph showing a part of clothes having a sintered metal portion containing a light-emitting substance. In the clothes shown in FIG. 8, a sintered metal portion containing a light-emitting substance is provided on a tab of a slider of a fastener.

FIG. 9 is a photograph showing a part of a metallic credit card having a sintered metal portion containing a light-emitting substance. In the metallic credit card shown in FIG. 9, three sintered metal portions each containing a light-emitting substance are provided on a front surface.

Furthermore, examples include articles in each of which a sintered metal portion containing the above-mentioned light-emitting substance is provided in a metal portion of a metal portion-containing article such as a household utensil, a tag for livestock, an aerospace component, a vehicle component, a household electrical appliance component, a housing construction component, or a structural component. More specifically, for example, a sintered metal portion having a two-dimensional bar code, in which information on quality assurance such as a producer name and a production date is recorded, can be provided on a structural component such as a bridge component by the above-mentioned method. Accordingly, a metal portion-containing article can carry the quality assurance, which have conventionally made use of a guarantee card or a quality assurance seal, and the information will not be lost even by abrasion and the like.

Furthermore, information for the purpose other than prevention of alteration or falsification and identification can be recorded. For example, information on the components, configuration, and the like of a metal portion-containing article, which have been conventionally described in an instruction manual, can be recorded. When a metal portion-containing article carries information on the components of the metal portion-containing article, the components can be determined easily at the time of recycling or the like.

FIG. 10 is a photograph showing a drug container with a lid having a sintered metal portion containing a light-emitting substance in a metal portion. In the drug container shown in FIG. 10, a sintered metal portion containing a light-emitting substance is provided on the lid.

FIG. 11 is a photograph showing a tag for livestock having a sintered metal portion containing a light-emitting substance. In the tag for livestock shown in FIG. 11, a sintered metal portion containing a light-emitting substance is provided on one surface.

FIG. 12 is a photograph showing a brake pad for an automobile having a sintered metal portion containing a light-emitting substance. In the brake pad for an automobile shown in FIG. 12, a sintered metal portion containing a light-emitting substance is provided on one surface.

FIG. 13 is a photograph showing an IC recorder having a sintered metal portion containing a light-emitting substance. In the IC recorder shown in FIG. 13, a sintered metal portion containing a light-emitting substance is provided on a casing.

FIG. 14 is a photograph showing an MD player having a sintered metal portion containing a light-emitting substance. In the MD player shown in FIG. 14, a sintered metal portion containing a light-emitting substance is provided on a casing.

FIG. 15 is a photograph showing a key having a sintered metal portion containing a light-emitting substance. In the key shown in FIG. 15, a sintered metal portion containing a light-emitting substance is provided on a key head.

Furthermore, it is also one preferable embodiment to use the metal portion-containing article of the present invention as an information recording medium. More specifically, the present invention provides an information recording medium having a porous metal portion (examples thereof preferably include a sintered metal portion and a sprayed metal portion), in which the porous metal portion contains a substance that emits light by irradiation with an electromagnetic wave, a part of the surface of the porous metal portion is a concave portion by pressing or laser application, the light emission of the substance that emits light by irradiation with an electromagnetic wave is suppressed in the concave portion, information is recorded in the concave portion and other portions of the surface of the porous metal portion, and the information is maintained at least until the concave portion wears out.

In the information recording medium of the present invention, the porous metal portion contains a substance that emits light by irradiation with an electromagnetic wave, a part of the surface of the porous metal portion is a concave portion obtained by pressing or laser application, the light emission of the light-emitting substance is suppressed in the concave portion, and information is recorded in the concave portion and other portions of the surface of the porous metal portion. In this information recording medium, recorded information is maintained at least until the concave portion wears out.

Examples of the information to be recorded include actual information such as a bar code and information such as an access code that is read with a detector of a mobile telephone or the like and accessible to a server or the like. The latter has an advantage of being accessible to a great amount of information stored in the server or the like, and also being accessible to secret information.

The applications of the metal portion-containing article of the present invention are not particularly limited, and the metal portion-containing article of the present invention can be used in a wide range of applications. Above all, the metal portion-containing article of the present invention is preferably used for an application to an expensive product that highly requires the prevention of alteration or falsification, such as a coin or a brand-name product.

The coin of the present invention is preferably used for hard money, a game token for a slot-machine pachinko (reel-type game machine), a slot machine, a TV game machine, or any other game facility.

### EXAMPLES

Hereinafter, the present invention will be described specifically by way of examples. It should be noted that the present invention is not limited thereto.

1. Production of a Metal Portion-containing Article

### Example 1

First, 100 parts by weight of powder of nickel silver (Cu: 64 wt %, Ni: 18 wt %, Zn: 18 wt %) and 0.5 part by weight of powder of a light-emitting substance (main component: BaMg₂Al₁₆O₂₇: Eu, Mn. The light-emitting substance emits light with a wavelength (emission wavelength) of a peak on the right side in FIG. 16 upon receiving light with a wavelength (light-receiving wavelength) in a range of a peak on the left side in FIG. 16. Hereinafter, the substance will be referred to as “UV Green”) were mixed for two hours using a double-cone type mixer, whereby mixed powder in which both the powders were uniformly mixed was obtained.

Then, the obtained mixed powder was placed in a die of a forming press, and compressed by upper and lower punches at a pressure of 3 t/cm² for 1.5 seconds, whereby a formed product in disc-shape with a diameter of 12 mm and a thickness of 1.3 mm (having a convex portion (height: 0.3 mm) in an 0-shape at the center of one surface) was obtained.

After that, the obtained formed product was allowed to pass through a sintering furnace at 800° C. The formed product was allowed to pass through a preheating portion, a sintering portion, and a cooling portion in the sintering furnace successively. In the sintering furnace, in order to remove oxygen on the surface of the mixed powder and provide hydrogen, ammonia-decomposing gas was used as sintering-reduction gas. When heating was started in the sintering furnace, particles of the powder were combined owing to the surface diffusion, and internal diffusion occurred also inside the particles when the heating temperature approached a melting point, whereby the particles were combined to obtain a sintered body.

The obtained sintered body was fitted in a hole inside an annular plate made of stainless steel SUS304 with an outer diameter of 25 mm, an inner diameter of 12 mm, and a thickness of 1.6 mm. The annular plate with the sintered body fitted therein was pressed from upper and lower directions to combine them, whereby a bimetal coin type metal portion-containing article was obtained. At this time, the O-shaped convex portion of the sintered body became substantially flat by pressing.

### Example 2

A metal portion-containing article was obtained by the same method as that of Example 1, except that 1.0 part by weight of powder of a light-emitting substance was mixed with 100 parts by weight of powder of nickel silver.

### Example 3

A metal portion-containing article was obtained by the same method as that of Example 1, except that 3.0 parts by weight of powder of a light-emitting substance was mixed with 100 parts by weight of powder of nickel silver.

### Example 4

First, 100 parts by weight of powder of nickel silver (Cu: 64 wt %, Ni: 18 wt %, Zn: 18 wt %) and 0.5 part by weight of powder of a light-emitting substance (UV Green) were mixed for two hours using a double-cone type mixer, whereby mixed powder in which both the powders were uniformly mixed was obtained.

Then, the obtained mixed powder was placed in a die of a forming press, and compressed by upper and lower punches at a pressure of 6 t/cm² for 2.5 seconds, whereby a formed product in disc-shape with a diameter of 25.4 mm and a thickness of 1.32 mm (having a concave in an M-shape or another pattern at the center of one surface) was obtained.

After that, the obtained formed product was allowed to pass through a sintering furnace at 800° C. The formed product was allowed to pass through a preheating portion, a sintering portion, and a cooling portion in the sintering furnace successively. In the sintering furnace, in order to remove oxygen on the surface of the mixed powder and provide hydrogen, ammonia-decomposing gas was used as sintering-reduction gas. When heating was started in the sintering furnace, particles of the powder were combined owing to the surface diffusion, and internal diffusion occurred also inside the powder when the heating temperature approached a melting point, whereby the particles were combined to obtain a metal portion-containing article composed of a sintered body.

### Example 5

A metal portion-containing article was obtained by the same method as that of Example 4, except that 1.0 part by weight of powder of a light-emitting substance was mixed with 100 parts by weight of powder of nickel silver.

### Example 6

A metal portion-containing article was obtained by the same method as that of Example 4, except that 3.0 parts by weight of powder of a light-emitting substance was mixed with 100 parts by weight of powder of nickel silver.

### Examples 7-12

Metal portion-containing articles were obtained by the same method of those of Examples 1-6, except that stainless steel SUS 304 (Fe: 74 wt %, Cr: 18 wt %, Ni: 8 wt %) was used in place of powder of nickel silver, the temperature of the sintering furnace was set to be 1,100° C., and nitrogen-decomposing gas was used as sintering-reduction gas.

### Example 13

First, powder of nickel silver (Cu: 64 wt %, Ni: 18 wt %, Zn: 18 wt %) was placed in a die of a forming press, and compressed by upper and lower punches at a pressure of 3 t/cm² for 1.5 seconds, whereby a formed product in disc-shape with a diameter of 12 mm and a thickness of 1.3 mm (having a convex portion (height: 0.3 mm) in an 0-shape at the center of one surface) was obtained.

After that, the obtained formed product was allowed to pass through a sintering furnace at 800° C. The formed product was allowed to pass through a preheating portion, a sintering portion, and a cooling portion in the sintering furnace successively. In the sintering furnace, in order to remove oxygen on the surface of the mixed powder and provide hydrogen, ammonia-decomposing gas was used as sintering-reduction gas. When heating was started in the sintering furnace, particles of the powder were combined owing to the surface diffusion, and internal diffusion occurred also inside the powder when the heating temperature approached a melting point, whereby the particles were combined to obtain a sintered body.

In a vacuum apparatus provided with a manual pressure reducing valve, 70 parts by weight of transparent polymethyl methacrylate (PMMA) was placed, and 30 parts by weight of powder of a light-emitting substance (UV Green) was placed while stirring. The PMMA and the powder of the light-emitting substance were mixed for 3 minutes while stirring, and thereafter, the sintered body obtained as described above was placed in the mixture. The pressure of the vacuum apparatus was reduced manually, whereby the light-emitting substance and PMMA were allowed to fill a void of a sintered metal portion. Then, the resultant sintered metal portion was allowed to stand for 5 hours to cure the PMMA.

After that, the obtained sintered body was fitted in a hole inside an annular plate made of stainless steel SUS304 with an outer diameter of 25 mm, an inner diameter of 12 mm, and a thickness of 1.6 mm. The annular plate with the sintered body fitted therein was pressed from upper and lower directions to combine them, whereby a bimetal coin type metal portion-containing article was obtained. At this time, the O-shaped convex portion of the sintered body became substantially flat by pressing.

### Example 14

A metal portion-containing article was obtained by the same method as that of Example 13, except that 1.0 part by weight of powder of a light-emitting substance was mixed with 100 parts by weight of powder of nickel silver.

### Example 15

A metal portion-containing article was obtained by the same method as that of Example 13, except that 3.0 parts by weight of powder of a light-emitting substance was mixed with 100 parts by weight of powder of nickel silver.

### Example 16

Powder of nickel silver (Cu: 64 wt %, Ni: 18 wt %, Zn: 18 wt %) was placed in a die of a forming press, and compressed by upper and lower punches at a pressure of 6 t/cm² for 2.5 seconds, whereby a formed product in disc-shape with a diameter of 25.4 mm and a thickness of 1.32 mm was obtained.

After that, the obtained formed product was allowed to pass through a sintering furnace at 800° C. The formed product was allowed to pass through a preheating portion, a sintering portion, and a cooling portion in the sintering furnace successively. In the sintering furnace, in order to remove oxygen on the surface of the mixed powder and provide hydrogen, ammonia-decomposing gas was used as sintering-reduction gas. When heating was started in the sintering furnace, particles of the powder were combined owing to the surface diffusion, and internal diffusion occurred also inside the particles when the heating temperature approached a melting point, whereby the particles were combined to obtain a sintered body.

After that, a concave portion in an M-shape or another pattern was formed by laser application on one surface of the sintered body.

In a vacuum apparatus provided with a manual pressure reducing valve, 70 parts by weight of transparent polymethyl methacrylate (PMMA) was placed, and 30 parts by weight of powder of a light-emitting substance (UV Green) was placed while stirring. The PMMA and the powder of the light-emitting substance were mixed for 3 minutes while stirring, and thereafter, the sintered body was placed in the mixture. The pressure of the vacuum apparatus was reduced manually, whereby the light-emitting substance and PMMA were allowed to fill a void of a sintered metal portion. Then, the resultant sintered metal portion was allowed to stand for 5 hours to cure the PMMA. As a result, a metal portion-containing article was obtained.

### Example 17

A metal portion-containing article was obtained by the same method as that of Example 16, except that 1.0 part by weight of powder of a light-emitting substance was mixed with 100 parts by weight of powder of nickel silver.

### Example 18

A metal portion-containing article was obtained by the same method as that of Example 16, except that 3.0 parts by weight of powder of a light-emitting substance was mixed with 100 parts by weight of powder of nickel silver.

### Examples 19-24

Metal portion-containing articles were obtained by the same method of those of Examples 13-18, except that stainless steel SUS 304 (Fe: 74 wt %, Cr: 18 wt %, Ni; 8 t %) was used in place of powder of nickel silver, the temperature of the sintering furnace was set to be 1,100° C., and nitrogen-decomposing gas was used as sintering-reduction gas.

### Examples 25-48

Metal portion-containing articles were obtained by the same method as those of Examples 1-24, except that a light-emitting substance (main component: La₂O₂S: Eu. The light-emitting substance emits light with a wavelength (emission wavelength) of a peak on the right side in FIG. 17 upon receiving light with a wavelength (light-receiving wavelength) in a range of a peak on the left side of FIG. 17. Hereinafter, the substance will be referred to as “UV Red”) was used in place of the light-emitting substance “UV Green”.

### Examples 49-72

Metal portion-containing articles were obtained by the same method as those of Examples 1-24, except that a light-emitting substance (main component: rare earth oxysulfide. The light-emitting substance emits light with a wavelength (emission wavelength) of a peak on the left side in FIG. 18 upon receiving light with a wavelength (light-receiving wavelength) in a range of a peak on the left side of FIG. 18. Hereinafter, the substance will be referred to as “IR Red”) was used in place of the light-emitting substance “UV Green”.

### Example 73

A metal portion-containing article was obtained by the same method as that of Example 6, except that the mixed powder was compressed so that a convex portion constituting a two-dimensional bar code was formed.

### Example 74

A metal portion-containing article was obtained by the same method as that of Example 39, except that the article was not combined with an annular plate (that is, the article was not formed in a bimetal coin type).

### Example 75

Powder of nickel silver (Cu: 64 wt %, Ni: 18 wt %, Zn: 18 wt %) was placed in a die of a forming press, and compressed by upper and lower punches at a pressure of 6 t/cm² for 2.5 seconds, whereby a formed product in disc-shape with a diameter of 25.4 mm and a thickness of 1.32 mm was obtained.

After that, the obtained formed product was allowed to pass through a sintering furnace at 800° C. The formed product was allowed to pass through a preheating portion, a sintering portion, and a cooling portion in the sintering furnace successively. In the sintering furnace, in order to remove oxygen on the surface of the mixed powder and provide hydrogen, ammonia-decomposing gas was used as sintering-reduction gas. When heating was started in the sintering furnace, particles of the powder were combined owing to the surface diffusion, and internal diffusion occurred also inside the powder when the heating temperature approached a melting point, whereby the particles were combined to obtain a sintered body.

A concave portion in an M-shape or another pattern was formed by laser application on one surface of the sintered body.

After that, the surface on which the sintered body was impressed was covered with a cellophane tape so that a rectangular hole was formed at the center.

Then, the portion (rectangular hole at the center) not covered with the cellophane tape was coated and impregnated with a mixture obtained by mixing 30 parts by weight of powder of a light-emitting substance (UV Green) and 70 parts by weight of a sealer (PERMEATE containing 80 wt % of an alkoxysilane compound, produced by D and D Ltd.) for 15 seconds while stirring, whereby a metal portion-containing article was obtained.

2. Properties of a Metal Portion-containing Article

The cross-section of the metal portion-containing article obtained in Example 3 was obtained by means of a plane grinder so that the cross-section was vertical to the surface of the article. The obtained cross-section was observed with a scanning electron microscope.

FIG. 19 shows an electron micrograph at a magnification of 400. In FIG. 19, a portion appearing in a light color is a sintered body of nickel silver, a portion appearing in a dark color is a void, and a substantially center portion appearing in a circular shape is a light-emitting substance (UV Green). It is understood from FIG. 19 that the light-emitting substance is present in the void of the sintered portion of the metal portion-containing article of the present invention.

In addition, the cross-section of the metal portion-containing article obtained in Example 51 was obtained by means of a plane grinder so that the cross-section was vertical to the surface of the article. The obtained cross-section was observed with a scanning electron microscope.

FIG. 20 shows an electron micrograph at a magnification of 100. In FIG. 20, a portion appearing in a light color is a sintered body of nickel silver, a portion appearing in a dark color is a void, and a substantially center portion appearing in a circular shape is a light-emitting substance (IR Red). It is understood from FIG. 20 that the light-emitting substance is present in the sintered portion of the metal portion-containing article of the present invention.

3. Electromagnetic Wave Irradiation Test of a Metal Portion-containing Article

The surface containing a light-emitting substance of each of the metal portion-containing articles obtained in Examples 1-75 was irradiated with an electromagnetic wave in accordance with the light-emitting substance, and the state of light emission was visually observed. UV-rays with wavelengths of 290 to 350 nm were used as the electromagnetic waves in Examples 1-48, 73, and 75, and infrared rays with wavelengths of 900 to 950 nm were used as the electromagnetic wave in Examples 49-72, and 74.

Consequently, in Examples 1-3, 7-9, 13-15, and 19-21, green light emission from the sintered portion excluding the O-shaped portion was observed.

FIG. 21 show photographs of the sintered body (FIG. 21(A)) used in Example 15 and the metal portion-containing article obtained in Example 15 before irradiation with an electromagnetic wave (FIG. 21(B)) and during irradiation with an electromagnetic wave (FIG. 21(C)).

In FIG. 21, it is understood that the light emission in the O-shaped portion was suppressed and light was emitted inside and outside the O-shaped portion in the sintered portion.

Consequently, in Examples 4-6, 10-12, 16-18, and 22-24, green light emission from the portion excluding the M-shaped portion or the portion of another pattern was observed.

FIG. 22 show photographs of the metal portion-containing article obtained in Example 6 before irradiation with an electromagnetic wave (FIG. 22 (A)) and during irradiation with an electromagnetic wave (FIG. 22(B)).

In FIG. 22, it is understood that the light emission in the M-shaped portion or the portion of another pattern was suppressed and light was emitted in the portion excluding the M-shaped portion or the portion of another pattern.

In Examples 25-27, 31-33, 37-39, and 43-45, red light emission from the sintered portion excluding the O-shaped portion was observed.

In Examples 28-30, 34-36, 40-42, and 46-48, red light emission from the sintered portion excluding the M-shaped portion or the portion of another pattern was observed.

In Examples 49-51, 55-57, 61-63, and 67-69, red light emission from the sintered portion excluding the O-shaped portion was observed.

In Examples 52-54, 58-60, 64-66, and 70-72, red light emission from the sintered portion excluding the M-shaped portion or the portion of another pattern was observed.

In any case, the emission strength increased successively as the amount of a light-emitting substance increased.

In Example 73, green light emission from the two-dimensional bar code was observed. FIG. 23 shows a photograph of the metal portion-containing article obtained in Example 73 at the time of irradiation with an electromagnetic wave.

In Example 74, red light emission from the sintered portion excluding the O-shaped portion was observed in the same way as in Example 39. FIG. 24 show photographs in the case where the inside of the O-shaped portion of the metal portion-containing article obtained in Example 74 was irradiated with an electromagnetic wave (FIG. 24(A)) and in the case where the O-shaped portion was irradiated with an electromagnetic wave (FIG. 24(B)). It is understood from FIG. 24 that the light emission in the O-shaped portion was suppressed, and light was emitted inside the O-shaped portion.

In Example 75, green light emission from the portion not covered with a cellophane tape was observed. FIG. 25 shows a photograph of the metal portion-containing article obtained in Example 75 at the time of irradiation with an electromagnetic wave.

4. Light Emission Detecting Test of a Metal Portion-containing Article

A test of confirming whether or not the light emission of the metal portion-containing article of the present invention could be detected quantitatively was performed.

An apparatus including a light-emitting device (LSD, emission wavelength: 900 to 950 nm), a photoreceptor device (PD, light-receiving wavelength: 450 to 550 nm), a detector circuit, and an amplifier circuit (UPC 324C, single power source quad general-purpose operational amplifier circuit) was used as a detection apparatus. FIG. 26 shows a circuit diagram of the detector circuit, and FIG. 27 shows a circuit diagram of the amplifier circuit.

Using the detection apparatus, the metal portion-containing article obtained in Example 51 placed at a distance of 10 mm from the photoreceptor device was irradiated with an electromagnetic wave, the light emission was detected, and the emitted light was able to be amplified to be detected quantitatively.

1. A metal portion-containing article having a porous metal portion, in which the porous metal portion contains a substance that emits light by irradiation with an electromagnetic wave.

2. The metal portion-containing article according to claim 1, in which the porous metal portion is a sintered metal portion.

3. The metal portion-containing article according to claim 2, in which the sintered metal portion is a simple substance or an alloy of at least one kind of metal selected from the group consisting of iron, copper, aluminum, titanium, gold, and silver.

4. The metal portion-containing article according to claim 2, in which the sintered metal portion is brass, stainless steel, or copper.

5. The metal portion-containing article according to claim 1, in which the porous metal portion is a sprayed metal portion.

6. The metal portion-containing article according to claim 1, in which the porous metal portion contains two or more kinds of substances that emit light by the irradiation with electromagnetic waves having different emission wavelengths.

7. The metal portion-containing article according to claim 1, in which the electromagnetic wave is an infrared ray, UV-ray, X-ray, or γ-ray.

8. The metal portion-containing article according to claim 1, in which the porous metal portion further contains DNA.

9. The metal portion-containing article according to claim 1, having a metal portion other than the porous metal portion.

10. The metal portion-containing article according claim 1, in which a part of a surface of the porous metal portion is a concave portion obtained by pressing or laser application, and light emission of the substance that emits light by the irradiation with an electromagnetic wave is suppressed in the concave portion.

11. The metal portion-containing article according to claim 10, in which the surface of the porous metal portion constitutes a two-dimensional bar code.

12. A coin having a porous metal portion, in which the porous metal portion contains a substance that emits light by irradiation with an electromagnetic wave.

13. The coin according to claim 12, in which the porous metal portion is a sintered metal portion.

14. The coin according to claim 13, in which the sintered metal portion is a simple substance or an alloy of at least one kind of metal selected from the group consisting of iron, copper, aluminum, and titanium.

15. The coin according to claim 13, in which the sintered metal portion is brass, stainless steel, or copper.

16. The coin according to claim 12, in which the porous metal portion is a sprayed metal portion.

17. The coin according to claim 12, in which the porous metal portion contains two or more kinds of substances that emit light by the irradiation with electromagnetic waves having different emission wavelengths.

18. The coin according to claim 12, in which the electromagnetic wave is an infrared ray, UV-ray, X-ray, or γ-ray.

19. The coin according to claim 12, in which the porous metal portion further contains DNA.

20. The coin according to any claim 12, having a metal portion other than the porous metal portion.

21. The coin according to claim 20, in which the metal portion other than the porous metal portion is placed around the porous metal portion.

22. The coin according to claim 12, in which a part of a surface of the porous metal portion is a concave portion obtained by pressing or laser application, and light emission of the substance that emits light by the irradiation with an electromagnetic wave is suppressed in the concave portion.

23. The coin according to claim 22, in which the surface of the porous metal portion constitutes a two-dimensional bar code.

24. A method of producing the coin according to claim 13, including the steps of:
heating powder of at least one kind of metal to a temperature lower ti-ian a melting point of the metal; and
cooling the powder from the temperature, in which in the cooling step, the substance that emits light by the irradiation with an electromagnetic wave is added at a temperature equal to or lower than a stability presence temperature of the substance to obtain the sintered metal portion.

25. An information recording medium having a porous metal portion,
in which the porous metal portion contains a substance that emits light by irradiation with an electromagnetic wave,
a part of a surface of the porous metal portion is a concave portion obtained by pressing or laser application,
and light emission of the substance that emits light by the irradiation with an electromagnetic wave is suppressed in the concave portion, and
the surface of the porous metal portion records information in the concave portion and a portion other than the concave portion, and the information is maintained at least until the concave portion wears out.

26. The information recording medium according to claim 25, in which the porous metal portion is a sintered metal portion.

27. The information recording medium according to claim 25, in which the porous metal portion is a sprayed metal portion.
